(19) United States
(12) Patent Application Publication
(10) Pub. No.: US 2022/0068133 A1
(43) Pub. Date: Mar. 3, 2022

(54) METHOD FOR MANAGING DRIVING RECORD OF VEHICLE ON BASIS OF BLOCKCHAIN NETWORK, AND DEVICE AND SYSTEM FOR PERFORMING SAME

(71) Applicant: QUANTUM GATE INC., Seoul (KR)

(72) Inventors: Ju Yong BACK, Seoul (KR); Dong Won LEE, Seongnam-si (KR)

(73) Assignee: QUANTUM GATE INC., Seoul (KR)

(21) Appl. No.: 17/424,781

(22) PCT Filed: Sep. 7, 2020
(86) PCT No.: PCT/KR2020/012075

§ 371 Date: Jul. 21, 2021

(30) Foreign Application Priority Data
Sep. 6, 2019 (KR) 10-2019-0110840
Sep. 6, 2019 (KR) 10-2019-0110851

(51) Int. Cl. G08G 1/0968; G08G 1/01; B60W 40/09; G06Q 30/02; G06Q 20/36

(52) U.S. Cl. CPC G08G 1/096844; G08G 1/0116; B60W 40/09; B60W 2540/30; G06Q 20/36; G06Q 2220/00; G06Q 30/0208

(57) ABSTRACT

A method for managing the driving record of a vehicle based on a blockchain network includes: collecting, by a digital tachograph (DTG) terminal installed in a vehicle, the driving record information of the vehicle and traffic-related data on a road along which the vehicle is driving, and calculating, by the DTG terminal, a safe driving index based on the driving record information and the traffic-related data; and storing, by the DTG terminal, the driving record information, the traffic-related data, and the safe driving index in a blockchain network including the DTG terminal as a node.

### TECHNICAL FIELD

The embodiments disclosed herein relate to a method for managing the driving record of a vehicle based on a blockchain network, and a device and system for performing the same.

### BACKGROUND ART

Blockchain technology is a distributed data storage technology that duplicates data and stores it at multiple locations. According to blockchain technology, blocks in which data is stored are connected to each other through hash values, thereby ensuring the reliability of the stored data. Accordingly, it can be used in various fields requiring the reliability of stored data.

The Intelligent Transport System (ITS) is a transport structure and system for efficiently controlling traffic congestion and enhancing safety by using electric, electronic, and information & communication technologies.

In order for the ITS to provide traffic-related information or perform traffic-related control, it is necessary to collect traffic-related data from multiple vehicles. In this case, there is a problem in that it is difficult to verify the reliability of collected information. In addition, since collected information may contain personal information, high security is required.

In particular, each vehicle provides the driving record of the vehicle, collected through a digital tachograph (DTG) installed in the vehicle, to the ITS, and the ITS uses it when performing traffic management. If the driver of the vehicle freely forges or falsifies the driving record of the vehicle, the efficiency of traffic management may be decreased. Therefore, there is a need to develop a technology capable of increasing the reliability of the management of the driving record of a vehicle.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### DISCLOSURE

### Technical Problem

The embodiments disclosed herein are intended to provide a method and system for managing the driving record of a vehicle using a blockchain network.

### Technical Solution

The embodiments disclosed herein ensure the reliability of data by storing the driving records of vehicles collected through various devices in a blockchain network. In addition, it is determined whether safe driving has been performed based on the driving record of a vehicle, and a reward is provided to a user according to the result of the determination.

### Advantageous Effects

According to the embodiments disclosed herein, a user may be prevented from freely forging or falsifying a driving record by storing the driving record information of a vehicle in the blockchain network.

In addition, a safe driving index is calculated based on driving record information and a reward is provided to a user according to the safe driving index, thereby motivating the user to drive safely.

The effects that can be obtained by the embodiments disclosed herein are not limited to the above-described effects, and other effects that have not been described above will be clearly understood by those having ordinary skill in the art, to which the present invention pertains, from the following description.

### DESCRIPTION OF DRAWINGS

FIG. 1 is a diagram showing a driving record management system based on a blockchain according to an embodiment;

FIG. 2 is a diagram showing the configurations of blocks in which vehicle driving records are stored according to an embodiment;

FIG. 3 is a diagram showing the configuration of a DTG terminal (30) included in a driving record management system based on a blockchain according to an embodiment;

FIG. 4 is a flowchart illustrating a method of calculating a safe driving index based on driving record information and traffic-related data according to an embodiment; and

FIG. 5 is a flowchart illustrating a method of managing the driving record of a vehicle according to an embodiment.

### BEST MODE

According to an embodiment, there is disclosed a method for managing the driving record of a vehicle based on a blockchain network, the method including: collecting, by a digital tachograph (DTG) terminal installed in a vehicle, the driving record information of the vehicle and traffic-related data on a road along which the vehicle is driving, and calculating, by the DTG terminal, a safe driving index based on the driving record information and the traffic-related data; and storing, by the DTG terminal, the driving record information, the traffic-related data, and the safe driving index in a blockchain network including the DTG terminal as a node.

According to another embodiment, there is disclosed a computer-readable storage medium having stored thereon a program for performing a method for managing the driving record of a vehicle based on a blockchain network. In this case, the method includes: collecting, by a digital tachograph (DTG) terminal installed in a vehicle, the driving record information of the vehicle and traffic-related data on a road along which the vehicle is driving, and calculating, by the DTG terminal, a safe driving index based on the driving record information and the traffic-related data; and storing, by the DTG terminal, the driving record information, the traffic-related data, and the safe driving index in a blockchain network including the DTG terminal as a node.

According to another embodiment, there is disclosed a system for managing the driving record of a vehicle based on a blockchain network, the system including: a digital tachograph (DTG) terminal installed in a vehicle, and configured to collect the driving record information of the vehicle; an open data server configured to provide traffic-related data on a road along which the vehicle is driving; and a management server configured to manage a blockchain network including the DTG terminal as a node; wherein the DTG terminal receives the traffic-related data from the open data server, calculates a safe driving index based on the driving record information and the traffic-related data, and stores the driving record information, the traffic-related data, and the safe driving index in the blockchain network.

### Mode for Invention

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

First, the meanings of the terms frequently used herein are defined.

‘Driving record information’ refers to driving-related information that is collected while a vehicle is driving. For example, the driving record information may include a vehicle's instantaneous speed, acceleration, engine revolutions per minute (RPM), brake operation status, the location of the vehicle, tire pressure, engine temperature, a load weight measurement, the remaining fuel level, door lock release status, a driving date, driving time, a driving distance, and/or the like. Furthermore, the driving record information may further include vehicle information (e.g., a vehicle number, a vehicle identification number, and/or the like) for the identification of the vehicle and personal information (e.g., a name, an age, and/or the like) for the identification of a user driving the vehicle. In addition, the driving record information may include various types of information related to the driving of the vehicle.

‘Traffic-related data’ refers to a broad concept including all types of data that can affect traffic, such as traffic regulations, traffic conditions (e.g., the number and speed of vehicles on a road, and/or the like), road conditions (e.g., road conditions such as icing or construction, and/or the like), weather conditions, etc.

A ‘safe driving index’ is a numerical expression of the degree to which the driver of a vehicle drives safely. The safe driving index may be calculated by comprehensively considering the driving record of a vehicle and traffic-related data around a road along which the vehicle has been driven. In the embodiments described herein, the safe driving index is normalized to have a value in the range from 0 to 100. As the value increases, driving becomes closer to safe driving.

Terms that are not defined above will be defined below whenever necessary.

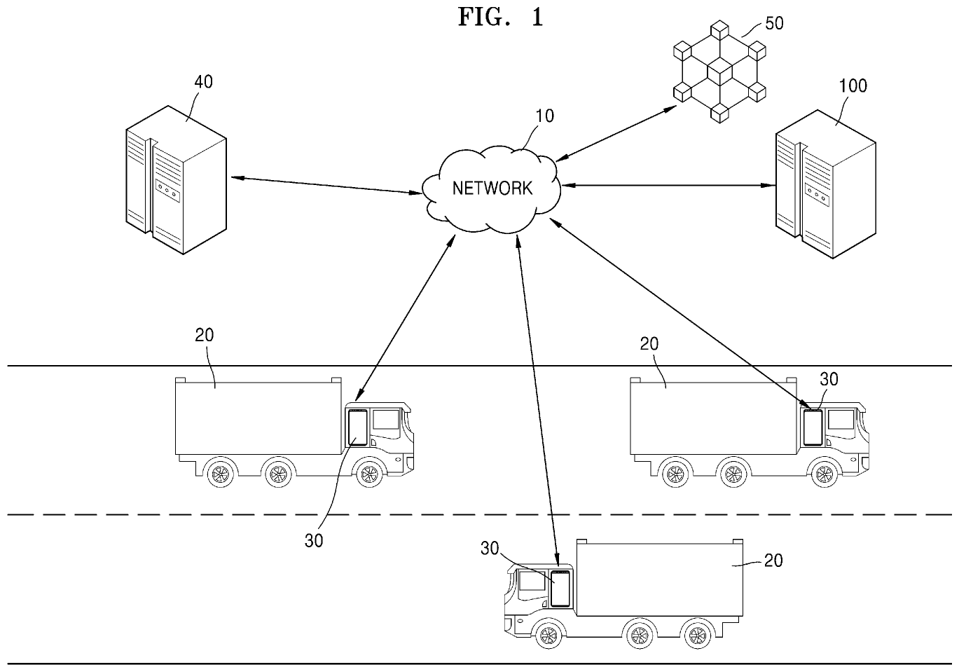

FIG. 1 is a diagram showing a driving record management system based on a blockchain according to an embodiment. Referring to FIG. 1, the driving record management system based on a blockchain according to the embodiment may include a network 10, vehicles 20, digital tachograph (hereinafter referred to as DTG) terminals 30, an open data server 40, a blockchain network 50, and a management server 100. Furthermore, although not shown in FIG. 1, the traffic management system based on a blockchain may further include various types of traffic facility infrastructure according to another embodiment.

The network 10 is a component that enables wired/wireless communication between the DTG terminals 30, the open data server 40, the blockchain network 50, and the server 100.

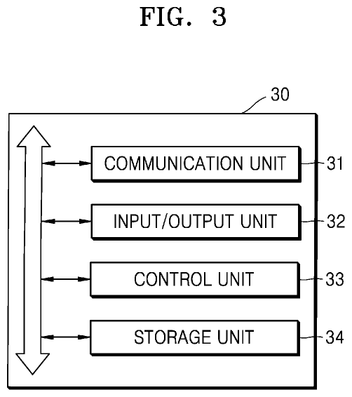

Each of the DTG terminals 30 installed in the vehicles 20 is a component that collects and stores the driving record information of the vehicle 20 in real time. The DTG terminal 30 may store the collected driving record information in the blockchain network 50. Furthermore, the DTG terminal 30 may calculate a safe driving index based on the driving record information. A detailed configuration and operation of the DTG terminal 30 will be described with reference to FIG. 3 below.

The open data server 40 is a component that provides traffic-related data. The DTG terminal 30 or the management server 100 may acquire various types of traffic-related data from the open data server 40. The traffic-related data provided by the open data server 40 may further include information about the history of traffic accidents, accident-prone areas, road hazard sections, protection sections for children or the elderly, and the like, in addition to the information described above. The open data server 40 may collect the above traffic-related data from organizations such as the Korean National Police Agency, the Korean Road Traffic Authority, and the Korean Meteorological Administration.

The blockchain network 50 is a site where the driving record information of vehicles 20 collected through the DTG terminals 30 is stored, and may be composed of a plurality of nodes each having a storage space. According to an embodiment, the individual DTG terminals 30 may become respective nodes and constitute the blockchain network 50. According to another embodiment, a blockchain network composed of the DTG terminals 30 is called a sub-blockchain, and the blockchain network 50 composed of separate electronic devices is called a main blockchain. The sub-blockchain and the main blockchain may be connected through the management server 100. In the following description, for convenience of description, it is assumed that the blockchain network 50 includes the DTG terminals 30 as nodes.

Not only the driving record information collected through the DTG terminals 30, but also the traffic-related data obtained from the open data server 40 and the safe driving index calculated by the DTG terminal 30 or the management server 100 may be stored together in the blockchain network 50.

A method by which information including a vehicle driving record is stored in the blockchain network 50 will be described as follows.

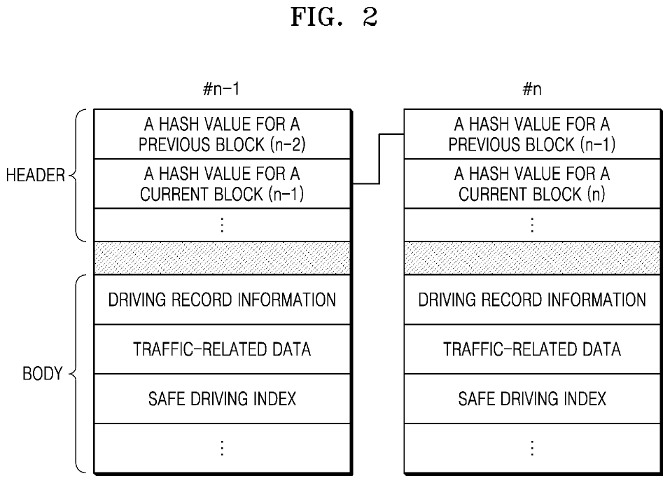

FIG. 2 is a diagram showing the configurations of blocks in which vehicle driving records are stored according to an embodiment. Digitized information may be distributed and stored in the blockchain network 50. Each block, which is each of the basic units stored in the blockchain network 50, includes a header and a body.

Referring to FIG. 2, the driving record information of the vehicle 20 is stored in the body of a block. In addition to the driving record information, traffic-related data and/or a safe driving index may be stored in the body of the block.

In the header of the block, a hash value for a previous block and a hash value for a corresponding block are stored. A hash value for a block refers to a hash value obtained by converting data, included in the body of the block, using a predetermined hash function. The hash value for the corresponding block is stored as a ‘hash value for the previous block’ in the header of a subsequent block, so that the blocks are connected to each other. In addition, values such as version and nonce values may be stored in the header of the block. Since this is related with general blockchain technology, a detailed description thereof will be omitted.

The blocks generated in the above-described way are distributed and stored in nodes constituting parts of the blockchain network 50, and a hash value for a specific block is stored in both the header of a corresponding block and the header of a subsequent block. Accordingly, reliability between distributed and stored data may be ensured.

According to an embodiment, a block is generated by the DTG terminal 30 and stored in the DTG terminal 30, and the management server 100 may be involved in the process of generating and storing the block. The process of generating and storing a block will be described below with reference to FIG. 3.

The management server 100 may be involved in the process of storing the driving record information, collected by the DTG terminal 30, in the block chain network 50. In an embodiment, the management server 100 may calculate a safe driving index in place of the DTG terminal 30. Furthermore, when the DTG terminals 30 constitute a sub-blockchain as described above, the management server 100 may connect the sub-blockchain to a main blockchain separately constructed.

FIG. 3 is a diagram showing the configuration of the DTG terminal 30 included in a driving record management system based on a blockchain according to an embodiment. In the embodiments described herein, the role of the DTG terminal 30 may be performed by a mobile terminal such as a smartphone or a tablet PC through the execution of an application. Accordingly, the term ‘DIG terminal’ used herein is viewed as including various types of mobile terminals that perform a digital driving record function through an application.

Referring to FIG. 3, the DTG terminal 30 according to an embodiment may include a communication unit 31, an input/output unit 32, a control unit 33, and a storage unit 34.

The communication unit 31 is component that performs wired/wireless communication with other devices. To this end, the communication unit 31 may be configured as a chipset that supports various types of wired and wireless communication protocols. The DTG terminal 30 may transmit and receive data to and from other devices connected to the network 10 through the communication unit 31.

The input/output unit 32 is a component that receives data and a command and outputs results obtained by processing the data according to the command. The input/output unit 32 may include input components such as hard buttons and a touch screen, and output components such as LCDs and OLEDs. According to an embodiment, the DTG terminal 30 may receive driving record information from various sensors (e.g., a speedometer, a camera, an infrared sensor, radar, LiDAR, an ultrasonic sensor, etc.) installed in the vehicle 20 through the input/output unit 32, and may output information regarding a safe driving index calculated based on the driving record information and a reward provided according to the safe driving index. In addition, the input/output unit 32 may receive driving record information collected through various sensors (e.g., a camera, an infrared sensor, radar, LiDAR, an ultrasonic sensor, etc.) provided in the DTG terminals 30.

Furthermore, the input/output unit 32 may receive traffic-related data necessary for calculating the safe driving index from the open data server 40 through the communication unit 31.

The control unit 33 is a component including at least one processor such as a CPU, and controls the overall operation of the DTG terminal 30. The control unit 33 may store driving record information in the blockchain network 50 or calculate a safe driving index based on the driving record information by executing a program stored in the storage unit 34, which will be described later.

A method by which the control unit 33 stores driving record information in the blockchain network 50 will be described in detail below.

As described above, the DTG terminal 30 may be a node constituting a part of the blockchain network 50. Accordingly, the control unit 33 may generate a block including driving record information and store it in the storage unit 34 of the DTG terminal 30.

According to an embodiment, the management server 100 may transmit block generation permission information (e.g., a registration key) to the DTG terminal 30 for the purpose of generating a block, and may generate unique block generation permission information for each DTG terminal 30 and transmit it. The management server 100 may manage information about the DTG terminal 30 configured to generate a block by using the block generation permission information.

The control unit 33 may encrypt the driving record information and generate a block by using the block generation permission information received from the management server 100. In this way, the driving record information is encrypted and stored, and thus the forgery and falsification of the information may be prevented.

A block may include a hash value for each of the block number of the corresponding block, driving record information, and block generation permission information, and may include both a hash value for a previous block and a hash value for a corresponding block. The process of obtaining a hash value for a corresponding block is now described. A hash value obtained by applying hash values included in a corresponding block (hash values for a previous block, a block number, driving record information, and block generation permission information) as input to a hash function becomes a hash value for the corresponding block. In this case, the ‘block number’ is a value indicating a sequential position at which the corresponding block was generated. Each block is configured to include a hash value for a previous block, and thus all blocks may be connected in the form of a blockchain, thereby effectively preventing the forgery and falsification of information.

The control unit 33 of the DTG terminal 30 may encrypt driving record information, block generation permission information, and each block by converting them into hash values using a hash function.

The control unit 33 may generate a hash value for a current block by configuring the hash values, into which the driving record information, the block generation permission information, and the block number have been converted, in the form of a Merkle tree. In detail, the control unit 33 may obtain a new hash value (parent data for leaf data) by first obtaining hash values (the leaf data) corresponding to the driving record information, the block generation permission information, and the block number and then concatenating the obtained hash values and the hash values for the previous block in pairs. The control unit 33 may repeat the above process until it can no longer pair two hash values, i.e., until only one hash value remains, and, finally, may store one remaining hash value (a Merkle tree root) in the header of the block. In this case, the Merkle tree root becomes a hash value for the current block, which can be used to generate a subsequent block. Since the hash value for the current block is related to all the information included in the block, it may be used to determine whether the information is forged or falsified.

When generating a hash value corresponding to block generation permission information, the control unit 33 may generate the hash value using random information obtained by converting seed information received from the management server 100. In this case, the seed information may be a unique identifier assigned to the DTG terminal 30 by the management server 100, and the control unit 33 of the DTG terminal 30 may generate random information by randomly converting the seed information as many times as the number of times corresponding to the block number of an operation information block to be generated. In this case, it is assumed that when specific seed information is randomly converted a specific number of times, random information having the same value is always generated. According to the assumption, for example, random information generated by randomly converting the seed information ‘100’ twice is always ‘45.’

The control unit 33 may generate a hash value corresponding to the block generation permission information by using the block generation permission information and the random information. Since the random information is used to generate the hash value as described above, security may be improved and the possibility of blocking the forgery and falsification of information may be increased.

According to one embodiment, when the control unit 33 stores the driving record information in the blockchain network 50, identity verification may be performed using the personal information of a user who has provided the driving record information, i.e., a user who drives the vehicle 20. This is intended to increase the reliability of the driving record information stored in the blockchain network 50 and to protect personal information included in the driving record information.

First, a preliminary preparation process for identity verification will be described.

A user's personal information is encrypted with a public key and stored in the storage unit 34 of the DTG terminal 30. The hash value of the encrypted personal information stored in the storage unit 34 is stored in a specific block, and the block number of the corresponding block is encrypted with the public key and stored in a third device (e.g., an authentication server) for the performance of verification.

Next, a verification process will be described.

When generating a block including driving record information and wanting to store it in the blockchain network 50, the control unit 33 transmits the hash value and private key of the encrypted personal information stored in the storage unit 34 to a third device. The third device decrypts a block number stored in advance using the received private key, compares the hash value of encrypted personal information stored in a block corresponding to the block number with the hash value of the encrypted personal information received from the DTG terminal 30, determines that identity verification is successful when they match each other, and then permits the generation and storage of the block.

A method by which the control unit 33 calculates a safe driving index by using driving record information and traffic-related data will be described in detail below.

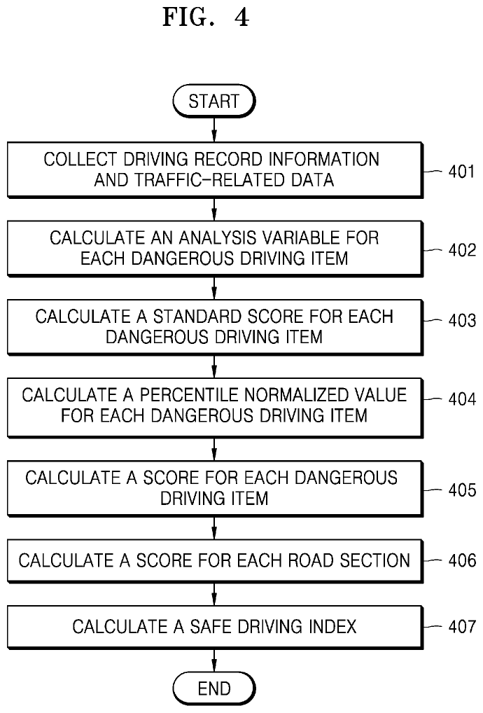

FIG. 4 is a flowchart illustrating a method of calculating a safe driving index according to an embodiment. Referring to FIG. 4, at step 401, the control unit 33 collects driving record information and traffic-related data. The control unit 33 may collect traffic-related data from the open data server 40 connected to the network 10 through the communication unit 31. Furthermore, the control unit 33 may collect traffic-related data on roads around the vehicles 20 through sensors (e.g., a camera, etc.) installed in the DTG terminals 30. The control unit 33 may extract information about ‘dangerous driving items’ from the collected information. In this case, the ‘dangerous driving items’ are factors used to calculate a safe driving index, as shown in Table 1 below, and a corresponding ‘danger level’ may be set for each of the dangerous driving items. However, the types of dangerous driving items and danger levels corresponding to the respective dangerous driving items shown in Table 1 are an example, and may be set differently from this example.

TABLE 1

| Dangerous Driving Item | Danger Level |
|---|---|
| Sudden start, and sudden stop | 1 |
| Sudden acceleration, sudden | 2 |
| deceleration, and speeding | |
| Prolonged speeding, sudden lane | 3 |
| change, and signal violation | |
| Sudden overtaking, sudden | 4 |
| left/right turn, sudden U-turn, | |
| and center line violation | |

Specific conditions that correspond to the dangerous driving items presented in Table 1 may be set in advance. The specific conditions that correspond to the dangerous driving items may be set differently for each type of vehicle 20, and Table 2 shows criteria for a case in which the vehicle 20 is a ‘truck’ and criteria for a case in which the vehicle 20 is a ‘bus.’ It is obvious that the conditions presented in Table 2 are also only an example, and the conditions may be appropriately modified according to the situation.

TABLE 2

| Dangerous Driving Item | | Criterion for Truck | Criterion for Bus |
|---|---|---|---|
| Speeding | speeding | In the case of driving at | In the case of driving at a |
| type | | a speed higher than a | speed higher than a road |
| | | road speed limit by 20 km/h | speed limit by 20 km/h |
| | prolonged | In the case of driving at | In the case of driving at a |
| | speeding | a speed higher than a | speed higher than a road |
| | | road speed limit by 20 | speed limit by 20 km/h for |
| | | km/h for 3 minutes or | 3 minutes or longer |
| | | longer | |
| Sudden | sudden | In the case of driving at | In the case of driving at |
| acceleration | acceleration | an acceleration of 5 km/h | an acceleration of 6 km/h |
| type | | or higher per second from | or higher per second from a |
| | | a speed of 6.0 km/h or | speed of 6.0 km/h or higher |
| | | higher | |
| | sudden start | In the case of driving at | In the case of driving at |
| | | an acceleration of 6 km/h | an acceleration of 8 km/h |
| | | or higher per second from | or higher per second from a |
| | | a speed of 5.0 km/h or | speed of 5.0 km/h or lower |
| | | lower | |
| Sudden | sudden | In the case where the | In the case where the speed |
| deceleration | deceleration | speed reaches 6.0 km/h or | reaches 6.0 km/h or higher |
| type | | higher after a | after a deceleration of 9 |
| | | deceleration of 8 km/h | km/h per second or higher |
| | | per second or higher | |
| | sudden stop | In the case where the | In the case where the speed |
| | | speed reaches 5.0 km/h or | reaches 5.0 km/h or lower |
| | | lower after a | after a deceleration of 9 |
| | | deceleration of 8 km/h | km/h per second or higher |
| | | per second or higher | |
| Sudden | sudden | In the case where the | In the case where the |
| lane | route | traffic lane is changed | traffic lane is changed to |
| change | change | to the left/right by | the left/right by 8°/sec or |
| type | | 6°/sec or larger based on | larger based on the driving |
| | | the driving direction at | direction at a speed of 30 |
| | | a speed of 30 km/h or | km/h or higher, the |
| | | higher, the accumulated | accumulated angle is |
| | | angle is ±2°/scc or | ±2°/sec or smaller for 5 |
| | | smaller for 5 seconds, | seconds, and the |
| | | and the | acceleration/deceleration |
| | | acceleration/deceleration | is ±2 km/h or lower |
| | | is ±2 km/h or lower | |
| | sudden | In the case where the | In the case where the |
| | overtaking | traffic lane is changed | traffic lane is changed to |
| | | to the left/right by | the left/right by 8°/sec or |
| | | 6°/sec or larger based on | larger based on the driving |
| | | the driving direction at | direction at a speed of 30 |
| | | a speed of 30 km/h or | km/h or higher, the |
| | | higher, the accumulated | accumulated angle is |
| | | angle is ±2°/sec or | ±2°/sec or smaller for 5 |
| | | smaller for 5 seconds, | seconds, and the |
| | | and the acceleration is 3 | acceleration is 3 krr/h or |
| | | km/h or higher | higher |
| Sudden | sudden | In the case where the | In the case where the speed |
| turn type | left/right | speed is 20 km/h or | is 25 km/h or higher and a |
| | turn (60 to | higher and a sudden turn | sudden turn to the |
| | 120°) | to the left/right is made | left/right is made within 4 |
| | | within 4 seconds (the | seconds (the accumulated |
| | | accumulated rotation | rotation angle is in the |
| | | angle is in the range of | range of 60 to 120°) |
| | | 60 to 120°) | |
| | sudden | In the case where the | In the case where the speed |
| | U-turn (160 | speed is 15 km/h or | is 20 km/h or higher and |
| | to 180°) | higher and driving to the | driving to the left/right |
| | | left/right is made within | is made within 8 seconds |
| | | 8 seconds (in the range | (in the range of 160 to |
| | | of 160 to 180°) | 180°) |

At step 402, the control unit 33 calculates an analysis variable x_{y} for each of the dangerous driving items.

In this case, i is an index value indicating a dangerous driving item. In other words, integers ranging from 1 may be sequentially assigned to the dangerous driving items shown in Table 1. For example, index values may be assigned in such a manner that 1 is assigned to a sudden start (i=1), 2 is assigned to a sudden braking (i=2), 3 is assigned to speeding (i=3), and so forth. In the following examples, it is assumed that i has a value in the range from 1 to n.

Meanwhile, a road on which the vehicle 20 travels may be divided into a plurality of sections according to a predetermined criterion (e.g., the same distance, the same driving time, or the like), and j is an index value indicating each of the sections. In the following examples, it is assumed that j has a value in the range from 1 to N.

A method by which the control unit 33 calculates an analysis variable x_{y} for each dangerous driving item for each of the road sections obtained through the division is as follows. The control unit 33 calculates an analysis variable x_{y} for each dangerous driving item by dividing a value, obtained by multiplying the number of occurrences of the dangerous driving item by a danger level corresponding to the dangerous driving item for a specific road section, by a ‘danger factor.’ In this case, the ‘danger factor’ is the square root of a value obtained by multiplying the ‘number of driving instances,’ which is the number of vehicles equipped with the DTG terminals 30 operated in the specific road section, and the ‘number of sections,’ which is the number of sections obtained through division.

For example, when an index corresponding to a sudden start is 1 (i=1) and an index corresponding to a second road section is 2 (j=2), the analysis variable x_{y} may be obtained as follows. It is assumed that the specific vehicle 20 makes three sudden starts in the second road section and there are a total of five vehicles (the number of driving instances) equipped with the DTG terminals 30 operating in the second road section. In addition, it is assumed that a road for which a driving record is managed is divided into a total of 10 (number of sections) sections.

First, the danger factor becomes \sqrt{5×10} because it is the square root of the product of the number of driving instances and the number of sections. The analysis variable x₁₂ becomes

$$\frac{3}{\sqrt{50}}$$

because it is a value obtained by dividing 3, which is a result value obtained by multiplying 3, which is the number of sudden starts, and danger level 1, which corresponds to a sudden start, by the danger factor. The control unit 33 calculates analysis variables for all the road sections and the dangerous driving items.

At step 403, the control unit 33 calculates a standard score zᵢⱼ for each dangerous driving item. The control unit 33 may calculate the standard score (z-score) zᵢⱼ of dangerous driving item i for section j according to Equation 1 below:

$${z}_{ij} = \frac{{x}_{ij} - {x}_{i}}{{σ}_{i}} \qquad ( 1 )$$

where xᵢ is the average of the analysis variables of the dangerous driving item i for all the road sections, and σᵢ is the standard deviation of the analysis variables of the dangerous driving item i for all the road sections.

At step 404, the control unit 33 calculates a percentile normalized value aᵢⱼ for each dangerous driving item. The control unit 33 may calculate the percentile normalized value aᵢⱼ of the analysis variable of the dangerous driving item i for the section j according to Equation 2 below:

$${a}_{ij} = \frac{{z}_{ij} - {min}_{i}}{{max}_{i} - {min}_{i}} \qquad ( 2 )$$

where minᵢ is the minimum value of the analysis variable of the dangerous driving item i for all the road sections, and maxᵢ is the maximum value of the analysis variable of the dangerous driving item i for all the road sections.

At step 405, the control unit 33 calculates a score yᵢⱼ for each dangerous driving item. The control unit 33 may calculate the score yᵢⱼ of the dangerous driving item i for the section j according to Equation 3 below:

yᵢⱼ=100−aᵢⱼ (3)

At step 406, the control unit 33 may calculate a score Aⱼ for each road section. The score for each road section refers to a score that reflects all the dangerous driving items that have occurred for a specific road section. The control unit 33 may calculate the score Aⱼ for the section j according to Equation 4 below:

Aⱼ=Σᵢ₌₁ⁿyᵢⱼ÷n (4)

At step 407, the control unit 33 finally calculates the safe driving index S. The control unit 33 may calculate the safe driving index S according to Equation 5 below:

S=Σⱼ₌₁^{N}Aⱼ÷N (5)

The calculation of the safe driving index according to the above-described method may be performed by the management server 100 rather than the DTG terminal 30. In other words, when the driving record information collected by the DTG terminal 30 is stored in the blockchain network 50, the management server 100 may access the blockchain network 50, may collect driving record information and traffic-related data, and may calculate a safe driving index according to the above-described process by using the above information.

The control unit 33 may store the calculated safe driving index in the blockchain network 50, and the process is the same as the above-described process of storing the driving record information in the blockchain network 50.

Furthermore, the control unit 33 may display the calculated safe driving index through the input/output unit 32 in real time, periodically, or whenever there is a user's request. The user may be motivated to drive safely by checking his or her own safe driving index.

The driving record management system based on a blockchain according to an embodiment may calculate a safe driving index based on driving record information, and may provide a reward to the user according to the calculated safe driving index. A method of managing a driving record of a vehicle and providing a reward based thereon will be described below.

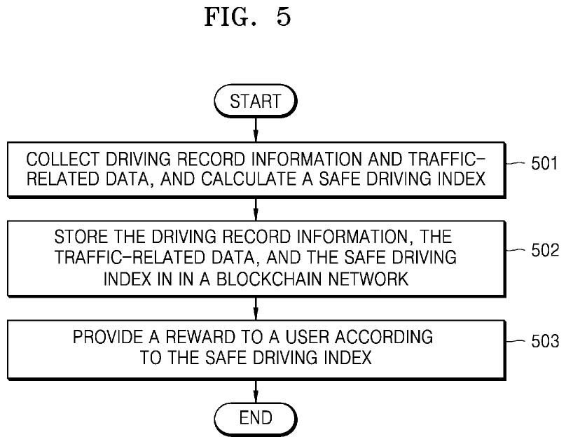

FIG. 5 is a flowchart illustrating a method of managing the driving record of a vehicle according to an embodiment. Referring to FIG. 5, at step 501, the DTG terminal 30 or the management server 100 collects driving record information and traffic-related data, and calculates a safe driving index. For example, the DTG terminal 30 may collect the driving record information of the vehicle 20 through a sensor provided in the vehicle 20, may access the open data server 40, and may collect traffic-related data for a road along which the vehicle 20 is traveling. In this case, the traffic-related data collected by the DTG terminal 30 may include situation information about the surroundings of the road along which the vehicle 20 is driving. A method of calculating a safe driving index based on driving record information and traffic-related data is the same as described above with reference to FIG. 4.

At step 502, the DTG terminal 30 or the management server 100 stores driving record information, traffic-related data, and a safe driving index in the blockchain network 50. A method of generating a block including the above-described information and storing it in the blockchain network 50 is the same as the method of storing the above-described driving record information in the blockchain network 50.

At step 503, the DTG terminal 30 or the management server 100 provides a reward to the user according to the safe driving index. The DTG terminal 30 or the management server 100 may calculate the size of the reward in proportion to the safe driving index, and may pay cryptocurrency or an electronic voucher corresponding to the calculated size of the reward to the user's electronic wallet. In this case, the paid cryptocurrency may be generated through mining when a block including driving record information is generated. As described above, the effect of inducing the user to drive safely may be expected by providing the reward to the user according to the safe driving index.

According to the above-described embodiments, the effect of preventing a user from freely forging or falsifying driving record information may be expected by storing and managing the driving record information of a vehicle through the blockchain network.

In addition, the effect of inducing a user to drive safely may be expected by providing a reward based on a safe driving index.

The term ‘unit’ used in the above-described embodiments means software or a hardware component such as a field-programmable gate array (FPGA) or application-specific integrated circuit (ASIC), and a ‘unit’ performs a specific role. However, a ‘unit’ is not limited to software or hardware. A ‘unit’ may be configured to be present in an addressable storage medium, and also may be configured to run one or more processors. Accordingly, as an example, a ‘unit’ includes components, such as software components, object-oriented software components, class components and task components, processes, functions, attributes, procedures, subroutines, segments in program code, drivers, firmware, microcode, circuits, data, a database, data structures, tables, arrays, and variables.

Each of the functions provided in components and ‘unit(s)’ may be coupled to a smaller number of components and ‘unit(s)’ or divided into a larger number of components and ‘unit(s).’

In addition, components and ‘unit(s)’ may be implemented to run one or more CPUs in a device or secure multimedia card.

The method for managing the driving record of a vehicle based on a blockchain network according to each of the above-described embodiments may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the method for managing the driving record of a vehicle based on a blockchain network according to each of the above-described embodiments may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the method for managing the driving record of a vehicle based on a blockchain network according to each of the above-described embodiments may be implemented in such a manner that the above-described computer program is executed by a computing device. The computing device may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing device. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued via the present specification should be defined by the attached claims, rather than the detailed description. All modifications and variations which can be derived from the meanings, scopes and equivalents of the claims should be construed as falling within the scope of the present invention.

1. A method for managing a driving record of a vehicle based on a blockchain network, the method comprising:
collecting, by a digital tachograph (DTG) terminal installed in a vehicle, driving record information of the vehicle and traffic-related data on a road along which the vehicle is driving, and calculating, by the DTG terminal, a safe driving index based on the driving record information and the traffic-related data; and
storing, by the DTG terminal, the driving record information, the traffic-related data, and the safe driving index in a blockchain network including the DTG terminal as a node.

2. The method of claim 1, wherein calculating the safe driving index comprises:
calculating an analysis variable for each dangerous driving item by using a number of occurrences of a predetermined dangerous driving item and a danger level corresponding to each dangerous driving item;
calculating a score for each dangerous driving item by using an average, standard deviation, minimum value, and maximum value of analysis variables;
calculating a score for each road section by summing scores for respective dangerous driving items for each road section; and
calculating the safe driving index by summing scores for respective road sections.

3. The method of claim 1, wherein storing the driving record information, the traffic-related data, and the safe driving index comprises:
performing identity verification using personal information of a user who drives the vehicle; and
if the identity verification is successful, generating a block including the driving record information, the traffic-related data, and the safe driving index, and storing it in the blockchain network.

4. The method of claim 3, wherein:
the personal information of the user is encrypted with a public key and stored in advance in the DTG terminal, a hash value of the encrypted personal information is recorded in any one block, and a block number of the block in which the hash value is stored is encrypted with the public key and stored in an authentication server; and
performing the identity verification comprises:
transmitting, by the DTG terminal, the hash value of the encrypted personal information stored in advance in the DTG terminal and a private key to the authentication server when intending to generate a block including the driving record information, the traffic-related data, and the safe driving index; and
decrypting, by the authentication server, the pre-stored block number using the received private key, comparing, by the authentication server, the hash value of the encrypted personal information stored in the block corresponding to the decrypted block number with the hash value of the encrypted personal information received from the DTG terminal, and determining, by the authentication server, that verification is successful when the two hash values match each other.

5. The method of claim 1, further comprising providing, by a management server, a reward to a user driving the vehicle according to the safe driving index.

6. The method of claim 5, wherein providing the reward comprises:
determining a size of the reward in proportion to the safe driving index; and
providing cryptocurrency or an electronic voucher corresponding to the size of the reward to an electronic wallet of the user.

7. The method of claim 1, wherein the driving record information comprises instantaneous speed, acceleration, and engine revolutions per minute of the vehicle, brake operation status, a location of the vehicle, tire pressure, engine temperature, a load weight measurement, a remaining fuel level, door lock release status, a driving date, driving time, and driving distance.

8. The method of claim 1, wherein the traffic-related data comprises situation information about surroundings of the road along which the vehicle is driving.

9. The method of claim 1, wherein the blockchain network comprises a sub-blockchain including a plurality of DTG terminals and a main blockchain including separate electronic devices, and a management server connects the sub-blockchain and the main blockchain to each other.

10. A computer-readable storage medium having stored thereon a program for causing a computer to perform the method set forth in claim 1.

11. A system for managing a driving record of a vehicle based on a blockchain network, the system comprising:
a digital tachograph (DTG) terminal installed in a vehicle, and configured to collect driving record information of the vehicle;
an open data server configured to provide traffic-related data on a road along which the vehicle is driving; and
a management server configured to manage a blockchain network including the DTG terminal as a node;
wherein the DTG terminal receives the traffic-related data from the open data server, calculates a safe driving index based on the driving record information and the traffic-related data, and stores the driving record information, the traffic-related data, and the safe driving index in the blockchain network.

12. The system of claim 11, wherein when the safe driving index is calculated, the DTG terminal calculates an analysis variable for each dangerous driving item by using a number of occurrences of a predetermined dangerous driving item and a danger level corresponding to each dangerous driving item, calculates a score for each dangerous driving item by using an average, standard deviation, minimum value, and maximum value of analysis variables, calculates a score for each road section by summing scores for respective dangerous driving items for each road section, and calculates the safe driving index by summing scores for respective road sections.

13. The system of claim 11, wherein the DTG terminal performs identity verification using personal information of a user who drives the vehicle, and, if the identity verification is successful, stores the driving record information, the traffic-related data, and the safe driving index in the blockchain network.

14. The system of claim 13, wherein:
the personal information of the user is encrypted with a public key and stored in advance in the DTG terminal, a hash value of the encrypted personal information is recorded in any one block, and a block number of the block in which the hash value is stored is encrypted with the public key and stored in an authentication server; and
when the identity verification is performed:
the DTG terminal transmits the hash value of the encrypted personal information stored in advance in the DTG terminal and a private key to the authentication server when intending to generate a block including the driving record information, the traffic-related data, and the safe driving index; and
the authentication server decrypts the pre-stored block number using the received private key, compares the hash value of the encrypted personal information stored in the block corresponding to the decrypted block number with the hash value of the encrypted personal information received from the DTG terminal, and determines that verification is successful when the two hash values match each other.

15. The system of claim 11, wherein the management server provides a reward to a user driving the vehicle according to the safe driving index.

16. The system of claim 15, wherein the management server determines a size of the reward in proportion to the safe driving index, and provides cryptocurrency or an electronic voucher corresponding to the size of the reward to an electronic wallet of the user.

17. The system of claim 11, wherein the driving record information comprises instantaneous speed, acceleration, and engine revolutions per minute of the vehicle, brake operation status, a location of the vehicle, tire pressure, engine temperature, a load weight measurement, a remaining fuel level, door lock release status, a driving date, driving time, and driving distance.

18. The system of claim 11, wherein the traffic-related data comprises situation information about surroundings of the road along which the vehicle is driving.

19. The system of claim 11, wherein the blockchain network comprises a sub-blockchain including a plurality of DTG terminals and a main blockchain including separate electronic devices, and the management server connects the sub-blockchain and the main blockchain to each other.
